(19) United States
(12) Patent Application Publication
(10) Pub. No.: US 2023/0249418 A1
(43) Pub. Date: Aug. 10, 2023

(54) METHOD FOR FORMING COMPOSITE MATERIAL AND JIG FOR FORMING COMPOSITE MATERIAL

(71) Applicant: MITSUBISHI HEAVY INDUSTRIES, LTD., Tokyo (JP)

(72) Inventors: Akihito SUZUKI, Tokyo (JP); Koichi HASEGAWA, Tokyo (JP); Satoshi OHMURA, Tokyo (JP); Tsuyoshi OKAWARA, Tokyo (JP); Hiromichi MATSUDA, Tokyo (JP)

(73) Assignee: MITSUBISHI HEAVY INDUSTRIES, LTD., Tokyo (JP)

(21) Appl. No.: 18/106,752

(22) Filed: Feb. 7, 2023

(30) Foreign Application Priority Data
Feb. 8, 2022 (JP) 2022-018036

(51) Int. Cl. B29C 70/44

(52) U.S. Cl. CPC B29C 70/44; B29K 2105/0872

(57) ABSTRACT

A method for forming a composite material that includes a product portion and a surplus portion formed on an end side of the product portion. The method includes placing in a forming jig having a forming surface the composite material before curing; and curing the composite material placed in the forming jig. The forming jig has a surplus forming section provided between the forming surface and the surplus portion. The surplus forming section is shaped in such a manner as to become thicker toward the outside of the composite material. The placing of the composite material includes mounting the surplus portion of the composite material on the surplus forming section to lift the surplus portion with respect to the product portion.

### CROSS-REFERENCE TO RELATED APPLICATIONS

The present application claims priority to and incorporates by reference the entire contents of Japanese Patent Application No. 2022-018036 filed in Japan on Feb. 8, 2022.

### FIELD

The present disclosure relates to a method for forming a composite material and a jig for forming a composite material.

### BACKGROUND

As a conventional method for forming a composite material, a method for manufacturing an FRP formed body has been known in which a reinforced fiber base material is impregnated with resin, the hand lay-up method is applied, and then vacuum forming is performed (see, for example, Patent Literature 1).

### CITATION LIST

### Patent Literature

Patent Literature 1: Japanese Patent Application Laid-open No. 2001-260239

### SUMMARY

### Technical Problem

Since a composite material to be formed loses and cannot hold its end shape during curing, an end of the composite material is formed as a surplus portion. The surplus portion of the composite material is then removed after forming. If the surplus portion of the composite material is large, the product portion obtained by removing the surplus portion of the composite material will be relatively small. This has made it difficult to efficiently form the product portion of the composite material.

Therefore, it is an object of the present disclosure to provide methods for forming a composite material and jigs for forming a composite material, the methods and the jigs being capable of efficiently forming a product portion of a composite material by reducing the size of a surplus portion to be formed.

### Solution to Problem

A method according to the present disclosure is for forming a composite material that includes a product portion and a surplus portion formed on an end side of the product portion. The method includes: placing in a forming jig having a forming surface the composite material before curing; and curing the composite material placed in the forming jig. The forming jig has a surplus forming section provided between the forming surface and the surplus portion. The surplus forming section is shaped in such a manner as to become thicker toward an outside of the composite material. The placing of the composite material includes mounting the surplus portion of the composite material on the surplus forming section to lift the surplus portion with respect to the product portion.

A method according to the present disclosure is for forming a composite material that includes a product portion and a surplus portion formed on an end side of the product portion. The method includes: placing in a forming jig having a forming surface the composite material before curing; placing in the surplus portion an additional material that is a resin-containing member; and curing the composite material placed in the forming jig. The curing of the composite material includes supplying the resin contained in the additional material to the composite material.

A jig according to the present disclosure is for forming a composite material that includes a product portion and a surplus portion formed on an end side of the product portion. The jig includes: a forming die having a forming surface; and a surplus forming section provided between the forming surface and the surplus portion. The surplus forming section is shaped in such a manner as to become thicker toward an outside of the composite material.

### Advantageous Effects of Invention

According to the present disclosure, the product portion of the composite material can be formed efficiently by reducing the size of the surplus portion to be formed.

### BRIEF DESCRIPTION OF DRAWINGS

FIG. 1 is a view schematically illustrating a jig for forming a composite material according to a first embodiment.

FIG. 2 is a view partially illustrating an example of the jig for forming a composite material according to the first embodiment.

FIG. 3 is a view partially illustrating an example of the jig for forming a composite material according to the first embodiment.

FIG. 4 is a view illustrating a method for forming a composite material according to the first embodiment.

FIG. 5 is a view partially illustrating an example of a jig for forming a composite material according to a second embodiment.

FIG. 6 is a view partially illustrating an example of the jig for forming a composite material according to the second embodiment.

FIG. 7 is a view illustrating a method for forming a composite material according to the second embodiment.

### DESCRIPTION OF EMBODIMENTS

Embodiments according to the present disclosure will be described in detail with reference to the drawings. These embodiments do not limit the invention. In addition, the components in the following embodiments include those that are easy and can be replaced by a person skilled in the art, or those that are substantially the same. The components described below can also be combined as appropriate, and if there are a plurality of embodiments, the embodiments can also be combined.

### First Embodiment

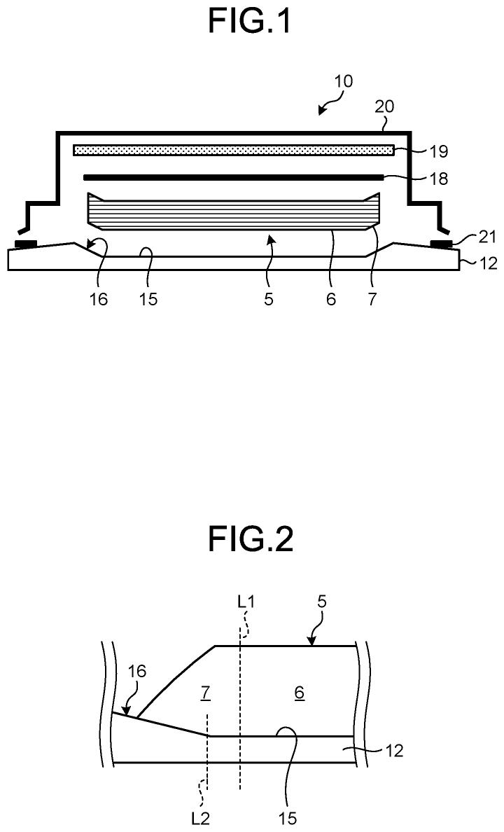

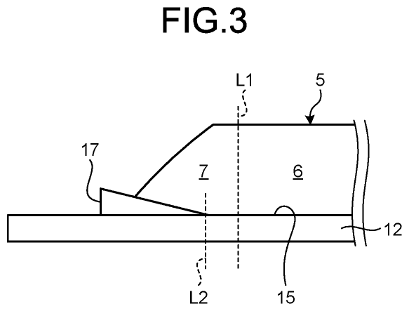

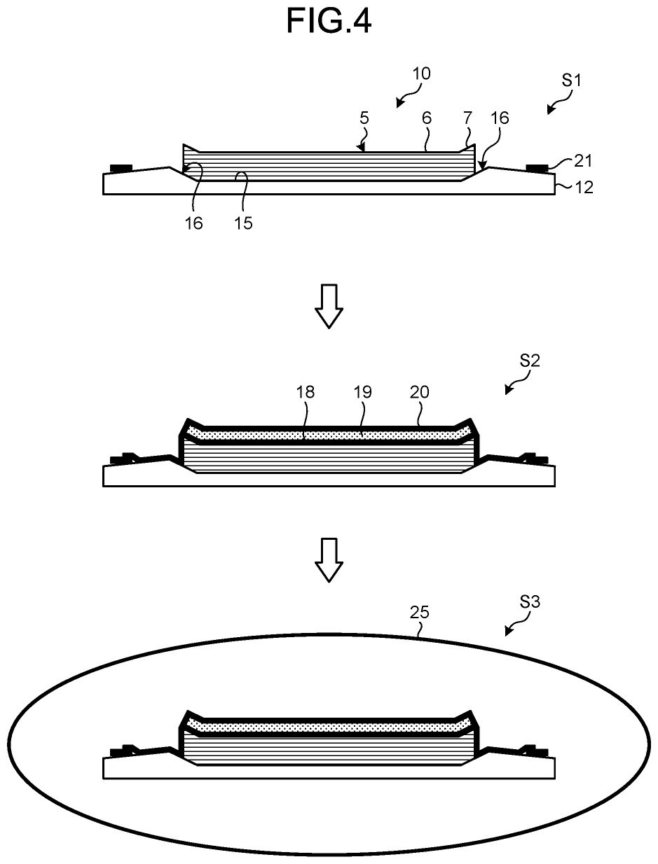

FIG. 1 is a view schematically illustrating a jig for forming a composite material according to the first embodiment. FIGS. 2 and 3 are views partially illustrating an example of the jig for forming a composite material according to the first embodiment. FIG. 4 is a view illustrating a method for forming a composite material according to the first embodiment.

A method for forming a composite material and a jig 10 for forming a composite material of the present disclosure are a method and a device for forming a composite material 5 that includes a product portion 6 and a surplus portion 7. In other words, the composite material 5 to be formed has the product portion 6 and the surplus portion 7 formed in one piece. The surplus portion 7 is formed at an end of the composite material 5. After forming, the surplus portion 7 of the composite material 5 is removed to form the product portion 6. In the first embodiment, the composite material 5 is a laminate made by laminating a plurality of resin-impregnated reinforced fiber sheets, and prepreg, for example, is applied as the reinforced fiber sheet. The composite material 5 is a laminate made up of multiple layers, but may also be a single layer, and is not particularly limited. The jig 10 for forming a composite material will be described next with reference to FIG. 1.

Jig for Forming Composite Material

The forming jig 10 includes a forming die 12, a surplus forming section 16, a release film 18, a breather 19, and a bagging film 20.

The forming die 12 has a forming surface 15, and is a profile for forming the composite material 5 that is placed on the forming surface 15. In the first embodiment, the forming die 12 is formed in a flat plate shape, for example. The forming die 12 is made of a metallic material, such as aluminum or iron, or a composite material. The composite material 5 placed in the forming die 12 may be formed with its ends aligned perpendicular to the forming surface 15, as illustrated in FIG. 1, or with its ends on a slant toward the product portion 6 side, as illustrated in FIG. 2.

The surplus forming section 16 is provided between the forming die 12 and the composite material 5 that is placed in the forming die 12. The surplus forming section 16 is integral with the forming die 12, as illustrated in FIG. 2. The surplus forming section 16 is shaped in such a manner as to become thicker toward the outside of the composite material 5 (from the product portion 6 to the surplus portion 7 side). Thus, the surplus forming section 16 has a flat inclined surface (top surface) that can prevent resin from flowing out of the composite material 5. The surplus forming section 16 may be of any shape as long as it is capable of preventing resin outflow. For example, the surface of the surplus forming section 16 may be curved.

The surplus forming section may be a surplus forming member 17 that is separate from the forming die 12, instead of the surplus forming section 16 illustrated in FIG. 2. The surplus forming member 17 is placed on the forming surface 15 of the forming die 12 and on the underside of the composite material 5, as illustrated in FIG. 3. The surplus forming member 17 is wedge-shaped in such a manner as to become thicker toward the outside of the composite material 5 (from the product portion 6 to the surplus portion 7 side). Thus, like the surplus forming section 16, the surplus forming member 17 also has a flat inclined surface (top surface) that can prevent resin from flowing out of the composite material 5. The surplus forming member 17 may also be of any shape as long as it is capable of preventing resin outflow. For example, the surface of the surplus forming member 17 may be curved.

The release film 18 is placed above the composite material 5 and between the composite material 5 and the breather 19. The release film 18 prevents the bonding between the composite material 5 and the breather 19, and serves as a sheet to separate the composite material 5 from the breather 19 after curing.

The breather 19 is placed above the release film 18 and between the release film 18 and the bagging film 20. The breather 19 serves as a component to exhaust the atmosphere inside the bagging film 20 that covers the composite material 5 in vacuuming during forming.

The bagging film 20 is placed above the breather 19. A sealing member 21 is provided between the bagging film 20 and the forming die 12. The interior of the bagging film 20 is thus hermetically sealed. The bagging film 20 is provided with a suction port (not illustrated)

Method for Forming Composite Material

A method for forming a composite material will be described next with reference to FIG. 4. As illustrated in FIG. 4, in the method for forming a composite material, the composite material 5 before curing is first placed in the forming die 12 of the forming jig 10 (step S1). At step S1, the surplus portion 7 of the composite material 5 is placed on the surplus forming section 16. At step S1, the product portion 6 of the composite material 5 is placed on the forming surface 15 of the forming die 12. Thus, at step S1, the surplus portion 7 of the composite material 5 is lifted with respect to the product portion 6.

At step S1, when the forming jig 10 illustrated in FIG. 2 is used, a plurality of resin-impregnated reinforced fiber sheets may be laminated to form the composite material 5 (laminate), and the formed composite material 5 may be placed in the forming jig 10. At step S1, when the forming jig 10 illustrated in FIG. 2 is used, a plurality of resin-impregnated reinforced fiber sheets may be laminated in the forming die 12 and the surplus forming section 16 of the forming jig 10 to form the composite material 5.

Furthermore, at step S1, when the forming jig 10 illustrated in FIG. 3 is used, the surplus forming member 17 is placed in the forming die 12, and then the composite material 5 formed in advance may be placed in the forming jig 10. At step S1, when the forming jig 10 illustrated in FIG. 3 is used, a plurality of resin-impregnated reinforced fiber sheets may be laminated in the forming die 12 of the forming jig 10 to form the composite material 5, and then the surplus forming member 17 may be placed between the forming die 12 and the surplus portion 7 of the composite material 5.

In the method for forming a composite material, after step S1 is performed, the composite material 5 placed in the forming jig 10 is cured (step S2 and step S3). Specifically, at step S2, the composite material 5 is covered with the release film 18, the breather 19, and the bagging film 20 in this order. Thereafter, at step S2, the composite material 5 is temporarily cured by heating while the interior of the bagging film 20 is vacuumed via the suction port not illustrated.

At step S3, the temporarily cured composite material 5 is heated in a heating furnace 25, such as an autoclave, which is at high temperature and high pressure, to execute regular curing of the composite material 5.

When the composite material 5 is heated at step S2 or step S3, the resin contained in the reinforced fiber sheet becomes easy to flow. Meanwhile, the forming jig 10 is provided with the surplus forming section 16 (surplus forming member 17), so that the resin flowing out of the composite material 5 can be held by the surplus forming section 16 (surplus forming member 17). Experiments have confirmed that the amount of resin flowing outward from the surplus portion 7 is reduced by approximately 20%.

After step S3 is performed, the composite material 5 is removed from the forming jig 10, whereby the composite material 5 including the product portion 6 and the surplus portion 7 is obtained.

The line L1 illustrated in FIGS. 2 and 3 is the boundary between the product portion 6 and the surplus portion 7, and the line L2 is the boundary between the forming die 12 and the surplus forming section 16 (surplus forming member 17). As described above, because the amount of resin flowing outward can be reduced, the distance between the line L1 and the line L2 can be shortened, for example, to about 0 mm to 20 mm.

### Second Embodiment

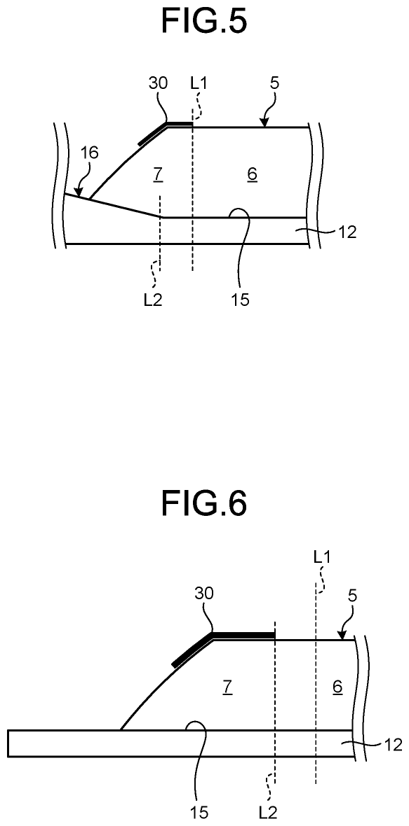

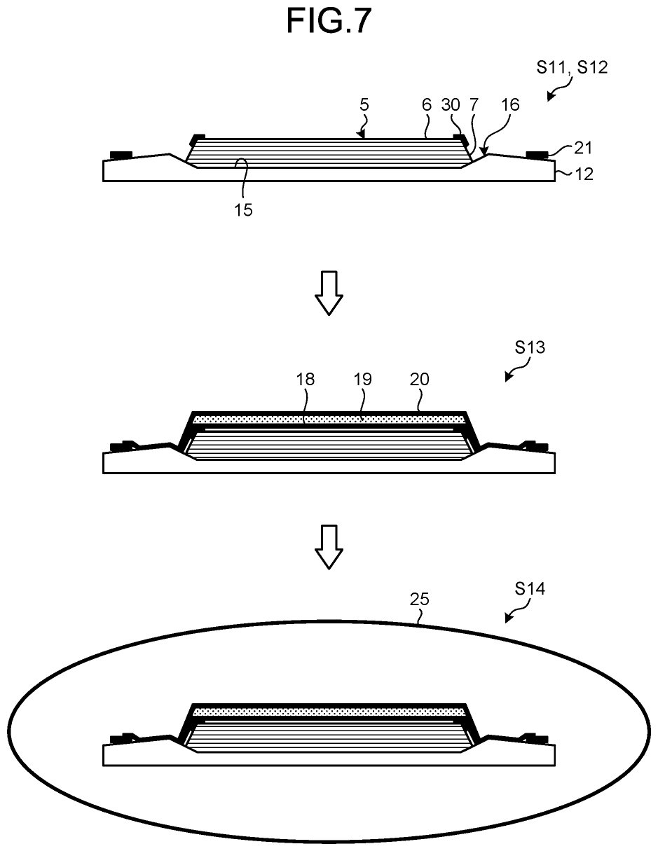

The second embodiment will be described next with reference to FIGS. 5 through 7. In the second embodiment, to avoid duplicate descriptions, parts that differ from those in the first embodiment will be described, and parts that have the same structure as that in the first embodiment will be described with the same reference signs. FIG. 5 is a view partially illustrating an example of a jig for forming a composite material according to the second embodiment. FIG. 6 is a view partially illustrating an example of the jig for forming a composite material according to the second embodiment. FIG. 7 illustrates a method of forming a composite material according to the second embodiment.

Method for Forming Composite Material

The method for forming a composite material illustrated in the second embodiment further performs step S12, at which an additional material 30, which is a resin-containing member, is placed in the surplus portion 7 of the composite material 5. The additional material 30 supplies the resin contained in the additional material 30 to the composite material 5 at steps S13 and S14, at which the composite material 5 is cured. The additional material 30 may be a resin sheet or a resin-impregnated reinforced fiber sheet (composite material) as long as the member contains resin.

The additional material 30 is placed on the top surface of the surplus portion 7 that is placed on the surplus forming section 16, as illustrated in FIG. 5. The additional material 30 may be placed in any way and be of any shape depending on the specifications of the composite material 5 to be formed. In other words, the additional material 30 is not limited to being placed on the top surface of the surplus portion 7, and may be placed on the underside of the surplus portion 7 or in the interior of the surplus portion 7. The additional material 30 may also be applied when a forming jig 10 from which the surplus forming section 16 is omitted is used, as illustrated in FIG. 6. In the case illustrated in FIG. 6, the additional material 30 is placed on the surplus portion 7 mounted on the forming surface 15 of the forming die 12.

The method for forming a composite material of the second embodiment will be described next with reference to FIG. 7. When the forming jig 10 illustrated in FIG. 5 is used, step S11 of the second embodiment is the same as step S1 of Form 1, and steps S13 and S14 of the second embodiment are the same as steps S2 and S3 of Form 1, so the explanation is omitted.

At step S12 at which the additional material 30 is placed, the additional material 30 is placed in the surplus portion 7 of the composite material 5. Step S12 is performed before or after step S11 depending on the position of the additional material 30 relative to the surplus portion 7. For example, when the additional material 30 is placed on the top surface of the surplus portion 7, the composite material 5 is formed, and then the additional material 30 is placed on the top surface of the surplus portion 7 of the composite material 5 at step S11. For example, when the additional material 30 is placed in the interior of the surplus portion 7, the additional material 30 is placed in the interior of the surplus portion 7 of the composite material 5 while reinforced fiber sheets are being laminated to form the composite material 5 at step S11. Furthermore, when the additional material 30 is placed on the underside of the surplus portion 7, the additional material 30 is placed on the top surface of the surplus forming section 16 (forming die 12 in FIG. 6) before the composite material 5 is formed at step S11.

In the method for forming a composite material of the second embodiment, step S12 can be performed to supply the resin contained in the additional material 30 to the composite material 5 at steps S13 and S14, at which the composite material 5 is cured.

When the forming jig 10 from which the surplus forming section 16 is omitted, which is illustrated in FIG. 6, is used, the composite material 5 is placed on the forming surface 15 of the forming die 12 at step S11 of the second embodiment. Steps S12 through S14 of the second embodiment are the same as above. In the case of FIG. 6, when the composite material 5 is heated at step S13 or step S14, the resin contained in the additional material 30 can be supplied to the composite material 5 although the resin flows out of the composite material 5.

As described above, the methods for forming a composite material and the jig 10 for forming a composite material described in the present embodiments are understood, for example, as follows.

A method for forming a composite material 5 according to a first aspect is a method for forming the composite material 5 that includes a product portion 6 and a surplus portion 7 formed on an end side of the product portion 6. The method includes: steps S1 and S11 of placing the composite material 5 before curing, in a forming jig 10 having a forming surface 15; and steps S2, S3, S13, and S14 of curing the composite material 5 placed in the forming jig 10. The forming jig 10 has a surplus forming section 16 (surplus forming member 17) provided between the forming surface 15 and the surplus portion 7. The surplus forming section 16 is shaped in such a manner as to become thicker toward the outside of the composite material 5. At steps S1 and S11 of placing, the surplus portion 7 of the composite material 5 is mounted on the surplus forming section 16 to lift the surplus portion 7 with respect to the product portion 6.

According to this structure, the resin can be prevented from flowing out of the composite material 5, thus preventing the surplus portion 7 from losing its shape. This allows the shape or thickness of the end of the composite material 5 to be held and the size of the surplus portion 7 to be formed to be reduced, thereby efficiently forming the product portion 6 of the composite material 5.

As a second aspect, the composite material 5 before curing is a laminate made by laminating a plurality of resin-impregnated reinforced fiber sheets, and at steps S1 and S11 of placing, the laminate formed in advance is placed in the forming jig 10.

According to this structure, placing the laminate formed in advance in the forming jig 10 enables the surplus portion 7 of the composite material 5 to be easily lifted and placed with respect to the product portion 6.

As a third aspect, the composite material 5 before curing is a laminate made by laminating a plurality of resin-impregnated reinforced fiber sheets, and at steps S1 and S11 of placing, the reinforced fiber sheets are laminated in the forming jig 10 to form the laminate.

According to this structure, the reinforced fiber sheets can be arranged following the shapes of the forming die 12 and the surplus forming section 16, to form the laminate.

As a fourth aspect, the surplus forming section (surplus forming member 17) is separate from the forming jig 10, the composite material 5 before curing is a laminate made by laminating a plurality of resin-impregnated reinforced fiber sheets, and at steps S1 and S11 of placing, the laminate formed in advance is placed in the forming jig 10, and then the surplus forming section is placed between the forming surface 15 and the surplus portion 7.

According to this structure, the surplus forming section can be placed after the composite material 5 is mounted in the forming jig 10, which enables accurate alignment of the surplus forming section with respect to the surplus portion 7 of the composite material 5.

As a fifth aspect, the method further includes step S12 of placing an additional material 30, which is a resin-containing member, in the surplus portion 7, and, at steps S13 and S14 of curing, the resin contained in the additional material 30 is supplied to the composite material 5.

According to this structure, even if the resin flows out of the composite material 5 during forming, the resin can be supplied from the additional material 30 to the composite material 5, thus preventing the surplus portion 7 from losing its shape.

A method for forming a composite material 5 according to a six aspect is a method for forming the composite material 5 that includes a product portion 6 and a surplus portion 7 formed on an end side of the product portion 6. The method includes: step S11 of placing the composite material 5 before curing, in a forming jig 10 having a forming surface 15; step S12 of placing an additional material 30, which is a resin-containing member, in the surplus portion 7; and steps S13 and S14 of curing the composite material 5 placed in the forming jig 10. At steps S13 and S14 of curing, the resin contained in the additional material 30 is supplied to the composite material 5.

According to this structure, even if the resin flows out of the composite material 5 during forming, the resin can be supplied from the additional material 30 to the composite material 5, thus preventing the surplus portion 7 from losing its shape. This allows the shape or thickness of the end of the composite material 5 to be held and the size of the surplus portion 7 to be formed to be reduced, thereby efficiently forming the product portion 6 of the composite material 5.

A jig 10 for forming a composite material 5 is a jig for forming the composite material 5 that includes a product portion 6 and a surplus portion 7 formed on an end side of the product portion 6. The jig includes: a forming die 12 having a forming surface 15; and a surplus forming section 16 (surplus forming member 17) provided between the forming surface 15 and the surplus portion 7, and the surplus forming section 16 is shaped in such a manner as to become thicker toward the outside of the composite material 5.

According to this structure, the resin can be prevented from flowing out of the composite material 5, thus preventing the surplus portion 7 from losing its shape. This allows the shape or thickness of the end of the composite material 5 to be held and the size of the surplus portion 7 to be formed to be reduced, thereby efficiently forming the product portion 6 of the composite material 5.

As an eighth aspect, the surplus forming section 16 is integral with the forming die 12.

According to this structure, simply placing the composite material 5 in the forming die 12 enables the surplus forming section 16 (surplus forming member 17) to lift the surplus portion 7 with respect to the product portion 6.

As a ninth aspect, the surplus forming section (surplus forming member 17) is separate from the forming die 12.

According to this structure, the surplus forming section can be placed after the composite material 5 is mounted in the forming die 12, which enables accurate alignment of the surplus forming section with respect to the surplus portion 7 of the composite material 5.

As a tenth aspect, the surplus forming section (surplus forming member 17) is wedge-shaped in such a manner as to become thicker from the product portion 6 side to the surplus portion 7 side.

According to this structure, the surplus forming section can be made into a simple shape, thus reducing the increase in cost of the forming jig 10.

### REFERENCE SIGNS LIST

5 Composite material
6 Product portion
7 Surplus portion
10 Forming jig
12 Forming die
15 Forming surface
16 Surplus forming section
17 Surplus forming member
18 Release film
19 Breather
20 Bagging film
21 Sealing member
25 Heating furnace

1. A method for forming a composite material that includes a product portion and a surplus portion formed on an end side of the product portion, the method comprising:
placing in a forming jig having a forming surface the composite material before curing; and
curing the composite material placed in the forming jig, wherein
the forming jig has a surplus forming section provided between the forming surface and the surplus portion,
the surplus forming section is shaped in such a manner as to become thicker toward an outside of the composite material, and
the placing of the composite material includes mounting the surplus portion of the composite material on the surplus forming section to lift the surplus portion with respect to the product portion.

2. The method for forming a composite material according to claim 1, wherein
the composite material before curing is a laminate made by laminating a plurality of resin-impregnated reinforced fiber sheets, and
the placing of the composite material includes placing the laminate formed in advance in the forming jig.

3. The method for forming a composite material according to claim 1, wherein
the composite material before curing is a laminate made by laminating a plurality of resin-impregnated reinforced fiber sheets, and
the placing of the composite material includes laminating the reinforced fiber sheets in the forming jig to form the laminate.

4. The method for forming a composite material according to claim 1, wherein
the surplus forming section is separate from the forming jig,
the composite material before curing is a laminate made by laminating a plurality of resin-impregnated reinforced fiber sheets, and
the placing of the composite material includes placing the laminate formed in advance in the forming jig, and then placing the surplus forming section between the forming surface and the surplus portion.

5. The method for forming a composite material according to claim 1, further comprising placing in the surplus portion an additional material that is a resin-containing member, wherein
the curing of the composite material includes supplying the resin contained in the additional material to the composite material.

6. A method for forming a composite material that includes a product portion and a surplus portion formed on an end side of the product portion, the method comprising:
placing in a forming jig having a forming surface the composite material before curing;
placing in the surplus portion an additional material that is a resin-containing member; and
curing the composite material placed in the forming jig, wherein
the curing of the composite material includes supplying the resin contained in the additional material to the composite material.

7. A jig for forming a composite material that includes a product portion and a surplus portion formed on an end side of the product portion, the jig comprising:
a forming die having a forming surface; and
a surplus forming section provided between the forming surface and the surplus portion, wherein
the surplus forming section is shaped in such a manner as to become thicker toward an outside of the composite material.

8. The jig for forming a composite material according to claim 7, wherein the surplus forming section is integral with the forming die.

9. The jig for forming a composite material according to claim 7, wherein the surplus forming section is separate from the forming die.

10. The jig for forming a composite material according to claim 9, wherein the surplus forming section is wedge-shaped in such a manner as to become thicker from the product portion side to the surplus portion side.
